(19) United States
(12) Patent Application Publication
(10) Pub. No.: US 2026/0300896 A1
(43) Pub. Date: Oct. 1, 2026

(54) METHODS AND SYSTEMS FOR DELIVERY VENDOR COORDINATION

(71) Applicant: BJ's Wholesale Club, Inc., Marlborough, MA (US)

(72) Inventors: Saranath RANGAMANNAR, Shrewsbury, MA (US); Edward HISER, JR., Bridgevile, PA (US); Anirudh BHARGAVA, Northborough, MA (US); Mohankumar SRINIVASAREDDY, Hopkinton, MA (US); Renjith RAMACHANDRAN, Hudson, MA (US); Divya JAYANTHI, Navi Mumbai (IN); Rahul CHAUDHARY, Redmond, WA (US)

(73) Assignee: BJ's Wholesale Club, Inc., Marlborough, MA (US)

(21) Appl. No.: 19/089,442

(22) Filed: Mar. 25, 2025

(51) Int. Cl. G06Q 10/0833; G06Q 10/083

(52) U.S. Cl. CPC G06Q 10/0833; G06Q 10/0838

(57) ABSTRACT

The present disclosure provides systems and methods for delivery. For example, methods provided herein may include obtaining, at a vendor hub, delivery vendor data and delivery data, identifying, in real-time, a set of available vendors based on a set of queries and a distance of each of a plurality of vendors from a delivery address, wherein the set of queries are executed in parallel to contact the plurality of vendors, generating, in real-time, an order for delivery based on at least one of delivery vendor data, the delivery data, and one or more events, and allocating the order for delivery to at least one of the set of available vendors.

### BACKGROUND

Current delivery vendor services allow organizations to manage and fulfill customer orders. These services facilitate tracking, inventory management, and customer satisfaction, helping companies to make informed operational decisions. Despite the advancements in delivery services, several challenges persist that can impact the efficiency and reliability of these services. Disparate data sources, inconsistent data formats, and incomplete datasets can lead to delays and errors in delivery. The complexity of current routing models can be resource-intensive for organizations. Additionally, over-reliance on historical data may not adequately account for rapid changes in consumer demand or emerging market trends.

Although current techniques for delivery services are based on technological advancements made over many years, current delivery techniques may still be ineffective to achieve ideal results. Accordingly, there is an impetus to improve delivery techniques to overcome current technological challenges by implementing improvements including, for example: enhancing the reliability of delivery services, increasing the reliability of on-time delivery, reducing inefficiencies associated with delivery processes, increasing the throughput of delivery operations, reducing errors associated with delivery logistics, decreasing the cost of delivery services, and the like.

Consequently, there exists a need for further improvements to delivery vendor services to overcome the aforementioned technical challenges and other challenges not mentioned.

### BRIEF SUMMARY

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Aspects of the present disclosure may include a system for delivery. The system for SDD may include a first database coupled to a first unit and configured to store delivery vendor data and deliver the delivery vendor data to the first unit. The system for delivery may include one or more communication managers implemented on a second unit and configured to deliver delivery data to the first unit. The system for delivery may include a vendor hub implemented on the first unit, the vendor hub comprising at least one of: a services manager configured to: identify, in real-time, a set of available vendors based on a set of queries and a distance of each of a plurality of delivery vendors from a delivery address, wherein the set of queries are executed in parallel to contact the plurality of delivery vendors; and an event manager configured to: generate, in real-time, an order for delivery based on at least one of delivery vendor data, the delivery data, and one or more events; and allocate the order for delivery to at least one of the set of available vendors.

Another aspect of the present disclosure may include a method for delivery. The method may include obtaining, at a vendor hub, delivery vendor data and delivery data. The method may include identifying, in real-time, a set of available vendors based on a set of queries and a distance of each of a plurality of vendors from a delivery address, wherein the set of queries are executed in parallel to contact the plurality of vendors. The method may include generating, in real-time, an order identification for delivery based on at least one of delivery vendor data, the delivery data, and one or more events. The method may include allocating the order for delivery to at least one of the set of available vendors.

Other aspects of the present disclosure provide: one or more devices (e.g., apparatuses) operable, configured, or otherwise adapted to perform the aforementioned methods as well as those described elsewhere herein; a non-transitory, computer-readable media including computer-executable instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus including means for performing the aforementioned methods as well as those described elsewhere herein. By way of example, an apparatus may include a processing system, or processing systems cooperating over one or more message passing interfaces.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

To easily identify the discussion of any particular element or act, the most significant digit or digits in a reference number refer to the figure number in which that element is first introduced.

FIG. 1 is a diagram of an example enhanced data processing architecture, implemented according to at least one aspect of the present disclosure.

FIG. 2 is a diagram of an example enhanced data processing architecture, implemented according to at least one aspect of the present disclosure.

FIG. 3 is a vendor diagram, implemented according to at least one aspect of the present disclosure.

FIG. 4 is a diagram illustrating parallel query operations, implemented according to at least one aspect of the present disclosure.

FIG. 5 depicts a schematic diagram illustrating communication pathways between a vendor hub 502, clubs, and vendors, implemented according to at least one aspect of the present disclosure.

FIG. 6 depicts an example constructed selection matrix, implemented according to at least on aspect of the present disclosure.

FIG. 7 depicts an example screenshot of a slot selection interface, implemented according to at least on aspect of the present disclosure.

FIG. 8 depicts an example screenshot of an expanded slot selection interface, implemented according to at least on aspect of the present disclosure.

FIG. 9 depicts a diagram of an example aggregation procedure, implemented according to at least on aspect of the present disclosure.

FIG. 10 depicts an example sheet of source events that are transformed to be internal events at the vendor hub, implemented according to at least on aspect of the present disclosure.

FIG. 11 depicts an example of expanded services with a one-to-many relationship with available delivery vendors, implemented according to at least on aspect of the present disclosure.

FIG. 12 is a diagram illustrating parallel query operations for expanded services, implemented according to at least one aspect of the present disclosure.

FIG. 13 is a flow diagram of an example method, implemented according to at least one aspect of the present disclosure.

FIG. 14 depicts a diagram of a system, implemented according to at least one aspect of the present disclosure.

FIG. 15 depicts a block diagram of a computer system that may be used to implement one or more of the systems or methods described herein in accordance with certain aspects.

FIG. 16 depicts a cloud computing environment that can be used to perform one or more actions according to an aspect of the present disclosure.

FIG. 17 depicts a block diagram of a computer system that may be used to implement one or more of the systems or methods described herein in accordance with certain aspects.

### DETAILED DESCRIPTION

Aspects of the present disclosure will now be described in detail with reference to the accompanying drawing figures. Like elements in the various figures may be denoted by like reference numerals. Further, in the following detailed description, specific details are set forth in order to provide a more thorough understanding of the claimed subject matter. However, it will be apparent to one of ordinary skill in the art that the aspects disclosed herein may be practiced without these specific details, or with details that are not described herein in the interest of clarity. Thus, in some instances, well-known features have not been described in detail to avoid unnecessarily complicating the description. Additionally, it will be apparent to one of ordinary skill in the art that the scale of the elements presented in the accompanying drawing figures may vary without departing from the scope of the present disclosure.

Aspects in accordance with the present disclosure generally relate to coordination and delivery management systems, and more particularly to an architecture framework for onboarding and managing Same Day Delivery (SDD) vendors with minimal effort.

Systems and methods presented herein utilize an enhanced architecture framework (e.g., a vendor hub) designed to streamline the onboarding process for new SDD vendors. Specifically, the systems and methods provided herein are capable of setting configurations at the vendor level and intelligently selecting a vendor for a customer based on various business configurations.

In at least one embodiment, the enhanced architecture framework provided herein enables customers to place home delivery orders that can be delivered in an efficient period (e.g., about two hours or less). The enhanced architecture framework may streamline the implementation of SDD order fulfilment by coordinating multiple delivery partners. The enhanced architecture framework can quickly onboard vendors and route orders to the vendors based on their serviceability and preferences. The enhanced architecture framework may then intelligently select the appropriate vendor and route the order accordingly. Vendor selection may be based on configurations, the region where the customer resides, the cost of delivery, the vendor performance index, and the like. Interacting systems and customers are not made aware of which vendor is fulfilling an order, as all such information is encapsulated within the enhanced architecture framework. Interfacing systems interact with minimal information, such as customers' delivery addresses. The enhanced architecture framework may also track orders end-to-end (e.g., until delivery), which may allow customers to track the status of their orders (e.g., in real-time). The enhanced architecture framework may be able to facilitate SDD of a wide array of products and accommodate assorted sizes (e.g., groceries, couches, furniture, bulk items). In certain embodiments, the enhanced architecture framework may be capable of delivering age-restricted products like alcohol.

In at least one example, the enhanced architecture framework may include enhanced serviceability procedures. The enhanced serviceability procedures may be capable of targeted selection of a delivery vendor for a delivery. The selection may be based on availability, distance, cost, preferences, a vendor performance index, and the like. In at least one non-limiting example, the enhanced serviceability procedures may be used for finding a delivery vendor who can deliver a products to customers in a cost effective manner. The enhanced serviceability procedures may begin when a customer enters a delivery address. The enhanced serviceability procedures may query for a set of nearby (e.g., nearest) clubs in a configured radius, based at least in part on the address entered. Queried clubs may then be sorted by distance. Once the clubs have been queried, the enhanced serviceability procedures identify active vendors cataloged in the enhanced architecture framework. After querying active vendors, the enhanced serviceability procedures perform a parallel availability query against each potential delivery vendor, identifying a club as the source address and identifying a customer address as the destination address. The enhanced serviceability procedures may then select clubs as selected delivery vendors in sequence and based on proximity, where each club is sorted based on proximity to the delivery address. In other words, the enhanced serviceability procedures select the nearest available club as the selected delivery vendor based on the queried data. Based on the selection, each delivery vendor may then refresh their delivery pick up location availability along associated delivery cost.

In at least one embodiment, a delivery pick up location can be a location anywhere near the club or the delivery address but should be within a pre-defined radius. The pre-defined radius may be pre-defined based on data from the enhanced architecture framework or may be manually entered. Where multiple delivery vendors are selected, each delivery vendor may share the cost associated with the delivery based on the proximity of their delivery pick up location. A delivery charge associated with the cost of an SDD may change based on the location of the delivery vendor or the location of the delivery pick up location associated with the delivery vendor.

In at least one embodiment, when a serviceability request is initiated by a user, enhanced serviceability procedures in the enhanced architecture framework collects all active and potential delivery vendors at that point of time. The enhanced architecture framework also collects each of the nearest clubs based on the customer address and confirms whether club is enabled for SDD. The enhanced architecture framework then implements the enhanced serviceability procedures, which may run in parallel to process identifiers (IDs) for each of the nearest clubs. Each sub-process of the enhanced serviceability procedures may evaluate one vendor at a time to confirm whether each club is currently available for service. In at least one embodiment, these procedures provide a serviceability check for each vendor via an application programming interface (API). The enhanced serviceability procedures may consolidate the results from each of the sub-processes and constructs the final serviceability response based on the results. In one non-limiting example, while constructing the serviceability response and choosing the delivery vendor, the enhanced architecture framework may apply vendor preference configurations, least cost logic, vendor performance index matrices, and the like.

### Aspects Related to Enhanced Architecture Framework

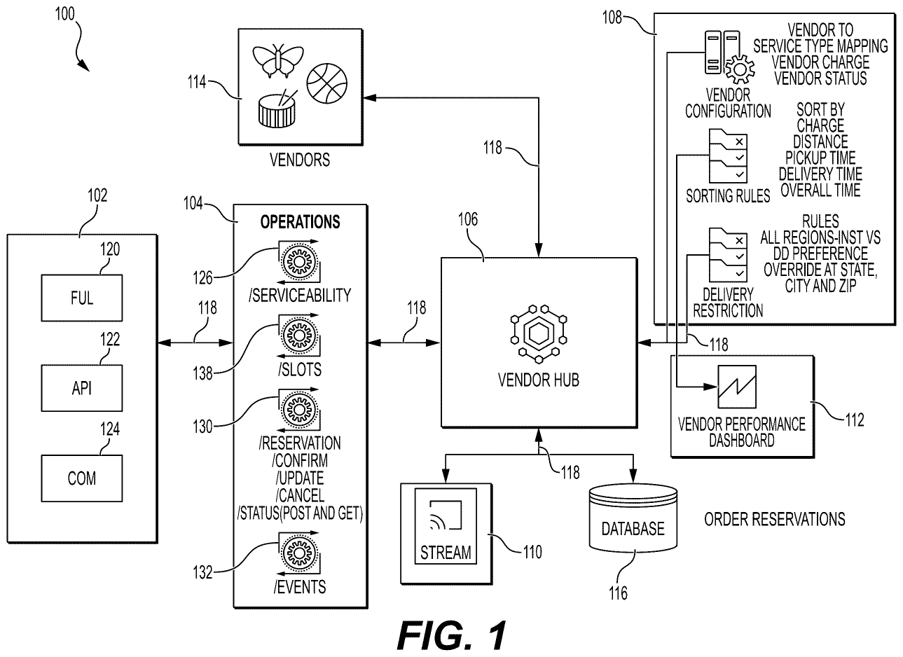

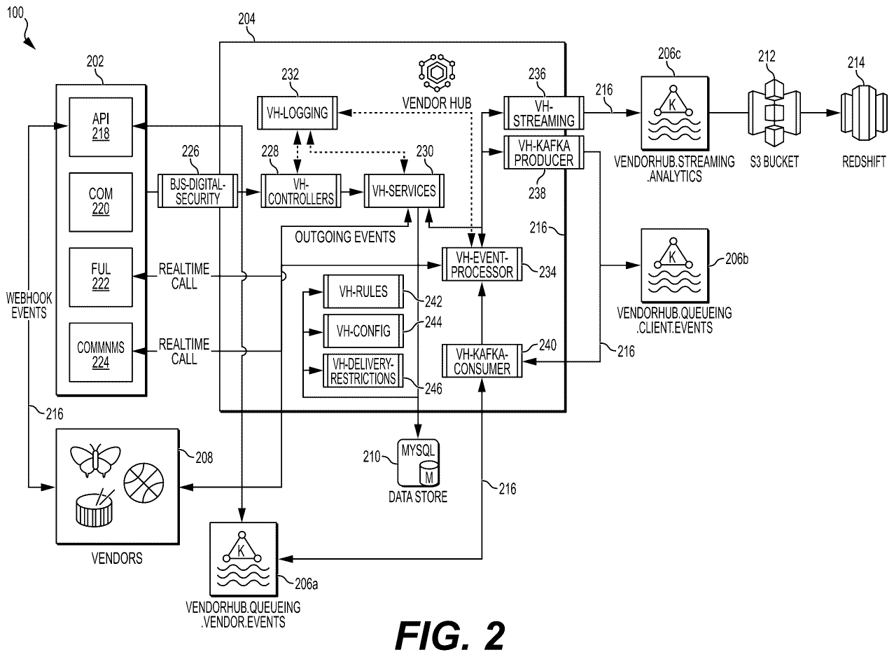

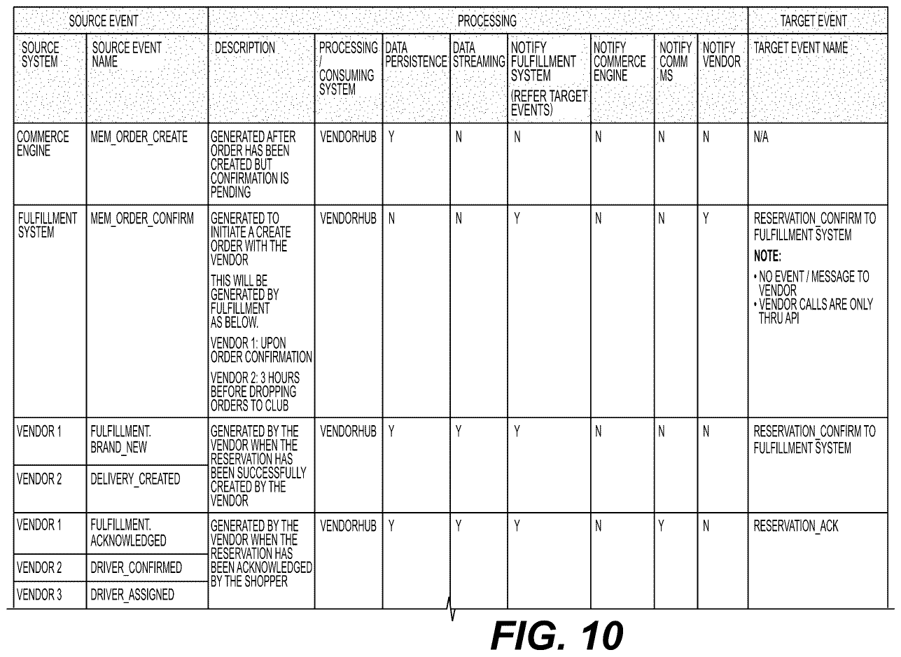

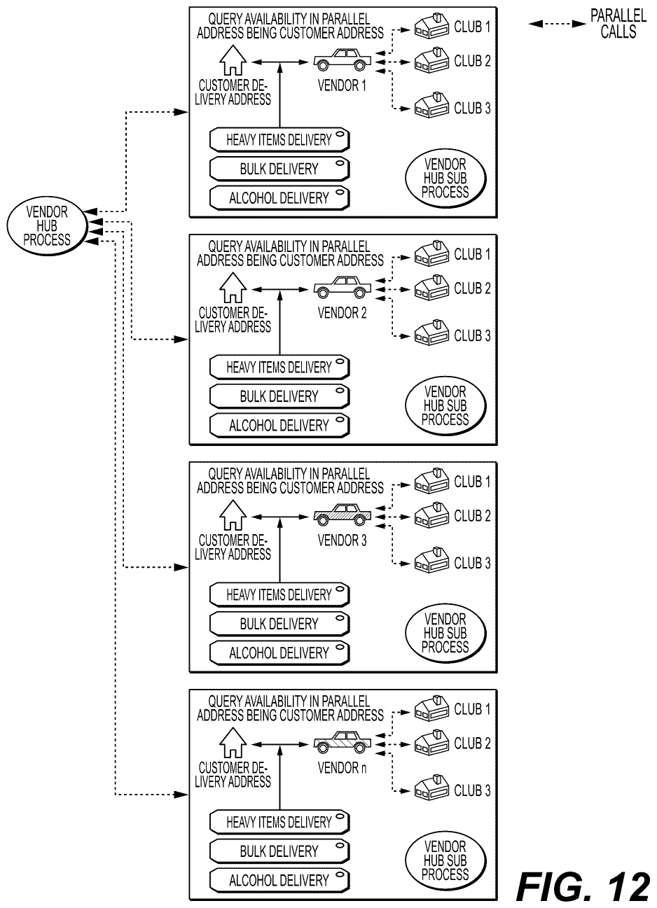

FIG. 1 illustrates an example of an enhanced architecture framework 100 (e.g., system, an enhanced architecture framework as described above, and the like), implemented according to at least one aspect of the present disclosure. In at least one aspect, the enhanced data processing architecture is configured or otherwise arranged to perform methods provided herein (e.g., method 1300 of FIG. 13). In at least one aspect, the enhanced architecture framework is configured or otherwise arranged to process data described in further detail with respect to FIG. 10. Additionally, it may be understood that features of FIGS. 2-9 are inherently and broadly described with respect to the enhanced data processing architecture of FIG. 1.

The enhanced data processing architecture of FIG. 1 includes unit 102, unit 104, unit 106, unit 108, device 110, device 112, API integration 114, and database 116. In at least one aspect, each of unit 102, unit 104, unit 106, unit 108, device 110, device 112, API integration 114, and/or database 116 may be practically implemented as one or more units, one or more databases, and/or one or more devices. In at least one aspect, each of unit 102, unit 104, unit 106, and unit 108 may have at least one memory and one or more processors having computer readable instructions stored thereon, which are capable of implementing enhanced data processing schemes as part of the enhanced architecture framework 100. In at least one aspect, unit 102, unit 104, unit 106, and/or unit 108 may have at least one memory and one or more processors having computer readable instructions stored thereon, which are capable of implementing enhanced data processing schemes as part of the function of the enhanced architecture framework 100. The one or more processor(s) of unit 102, unit 104, unit 106, and/or unit 108 may be central processing units (CPUs). The one or more processor(s) of unit 102, unit 104, unit 106, and/or unit 108 may be graphics processing units (GPUs). Where there is more than one processor, each processor may operate independently from one another or as part of the same network of controllers and/or systems. Where multiple processors are part of the same network of controllers and/or systems, they may operate in sequence with one another, in parallel with one another, as physical components of a shared virtual machine, or as components of server-less network capable of processing decomposed flow data (e.g., a Kubernetes-based architecture).

The enhanced architecture framework 100 further includes a network 118. In at least one aspect, network 118 may be practically implemented as one or more networks. Network 118 may be a wired network, a wireless network, or a combination of both. Network 118 may be capable of communicatively coupling components of enhanced architecture framework 100, as illustrated in FIG. 1. In at least one aspect, a wireless network may include a wireless local area network (WLANs) (e.g., a wireless fidelity (Wi-Fi) network), a wireless personal area networks (WPANs) (e.g., a Bluetooth network, a Zigbee network), a wireless metropolitan area network (WMANs) (e.g., a worldwide interoperability for microwave access (WiMAX) network), a wireless wide area network (WWANs) (e.g., a fourth generation long-term evolution (4G LTE) network, a fifth generation new radio (5G NR) network, satellite networks, mesh networks, ad hoc networks, near field communication (NFC) networks, infrared (IR) communication networks, ultra-wideband (UWB) networks, long range wide area networks (LoRaWAN) (e.g., a network optimized for Internet-of-Things (IoT) applicability), and the like.

In at least one embodiment, database 116 may be practically implemented as one or more databases. In at least one aspect, the database may include one or more of relational databases (RDBMS) which use structured query language (SQL) for data management, NoSQL databases (e.g., document stores, key-value stores, column-family stores, graph databases), in-memory databases, NewSQL databases, time-series databases, object-oriented databases, hierarchical databases, network databases, distributed databases, cloud databases, multimodel databases, embedded databases, and the like. Database 116 may be treated as a data warehouse, data lake, data well, or another storage system. Database 116 may be optimized for querying and analysis, allowing the enhanced data processing architecture methods described herein (e.g., method 1300).

In at least one embodiment, API integration 114 may be a real-time API integration. Real-time API integrations may involve a seamless connection of various systems and applications to allow instantaneous data exchange and interaction. These integrations may utilize advanced networking protocols (e.g., WebSockets or HTTP/2) to establish persistent, bidirectional communication channels between integrated systems, ensuring continuous data flow with minimal latency. The integration architecture may employ event-driven frameworks (e.g., Node.js) to handle asynchronous events and push real-time updates across connected systems. Real-time API integrations may be categorized based on their functionality and use cases.

In at least one embodiment, user device 110 and/or device 112 of enhanced architecture framework 100 include or incorporate a Kafka stream (not shown). In at least one aspect, device 110 and/or device 112 can be any electronic computing device. In one example, Kafka Streams represent a client library for building applications and microservices, where the input and output data are stored in Kafka clusters. A Kafka Streams enabled device allows for the continuous processing of real-time data streams with a high level of abstraction. In one example, Kafka Streams may operate by consuming data from Kafka topics, processing the data through a series of transformations, and then producing the transformed data back into Kafka topics. The processing is defined by a topology, which is a directed acyclic graph of stream processors (e.g., nodes) and the streams (e.g., edges) that connect them. Each stream processor can perform operations such as filtering, mapping, grouping, aggregating, joining, and windowing on the data. Kafka Streams ensures fault tolerance and scalability by distributing the processing load across multiple instances and by leveraging Kafka's inherent partitioning and replication mechanisms. State stores may also be used to maintain intermediate processing states, which are also backed up to Kafka topics to ensure durability and fault recovery. The library provides exactly-once processing semantics, ensuring that each record is processed once and only once, even in the face of failures. This is achieved through a combination of Kafka's transactional capabilities and the careful management of offsets and state.

In at least one embodiment, unit 102 may be a communication unit. Unit 102 may include one or more communication managers, here a fulfillment system 120 (e.g., “FUL”) an API gateway 122 (e.g., “API”), and a commerce engine 124 (e.g., “COM”). Fulfillment system 120 may be a system for processing and managing orders from various sales channels (e.g., user requesting SDD). Fulfillment system 120 may be arranged or otherwise configured to conduct order entry, manage delivery vendor inventory, enable order fulfillment, and facilitate customer communication. Fulfillment system 120 may allow for real-time visibility and accuracy in order tracking to improved operational efficiency. API gateway 122 may be API connection hub at unit 102 configured or otherwise arranged to manage and prioritize communication at unit 102. Commerce engine 124 may be a system configured or otherwise arranged to manage real-time operations within enhanced architecture framework 100.

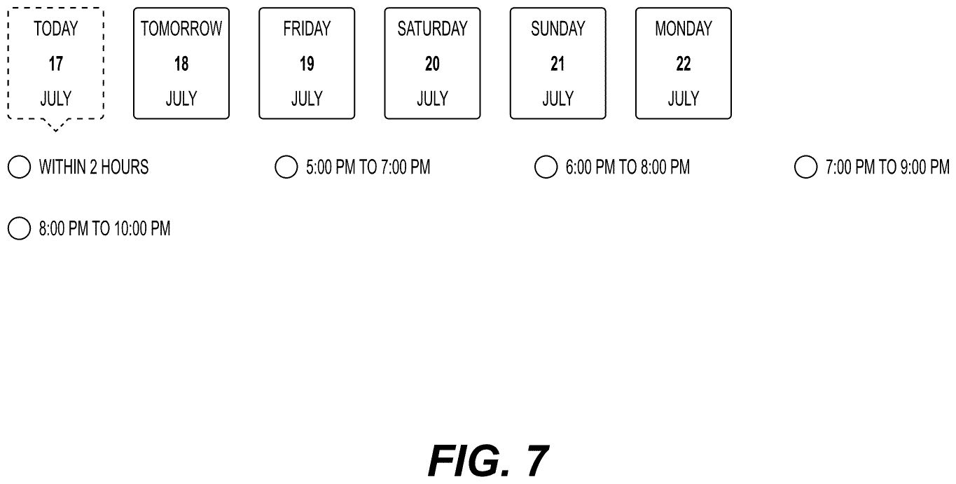

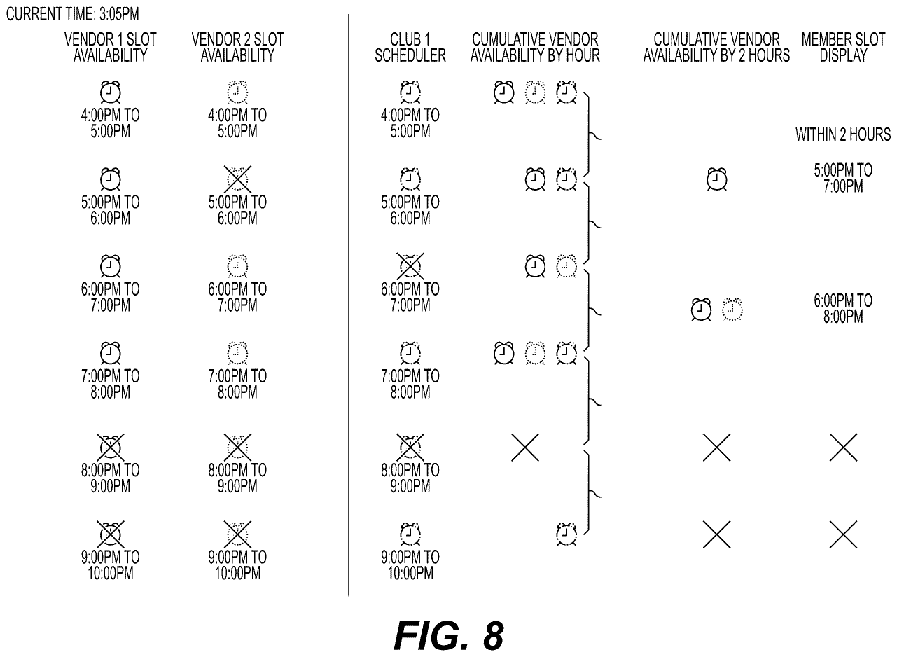

Unit 102 may be communicatively coupled to unit 104 via network 118. Output from unit 102 may be delivered to unit 104 via network 118. At unit 104, the output may be processed by any one of enhanced serviceability procedures 126, enhanced slot procedures 128, status procedures 130, and event procedures 132. Enhanced serviceability procedures 126 may include any enhanced serviceability procedures described above, where serviceability operations may allow enhanced architecture framework 100 to identify and validate delivery vendor availability for a targeted customer address. Enhanced slot procedures 128 may include any procedures described below with respect to FIGS. 7 and 8 and may allow enhanced architecture framework 100 to search for slots for delivery, for example by customer address. In certain cases, slots from different vendors may be aggregated. Status procedures 130 may include procedures to make or confirm a reservation (e.g., for SDD), procedures to confirm an order (e.g., for SDD), procedures to update an order (e.g., for SDD), procedures to cancel an order (e.g., for SDD), and/or procedures to retrieve status of an order (e.g., for SDD). In one example, a reservation operation associated with status procedures 130 may allow a client to make a reservation, update a reservation, cancel a reservation, and get the status of the reservation. Status procedures 130 may be accessible by enhanced architecture framework 100 administrative users, clients, customers, and/or delivery vendors. Event procedures 132 may include procedures to schedule and/or coordinate operations associated with a given ordering event. In one example, event procedures 132 may process events from different delivery vendors and clients like fulfillment system, commerce engine, API gateway to notify other systems in communication with enhanced architecture framework 100.

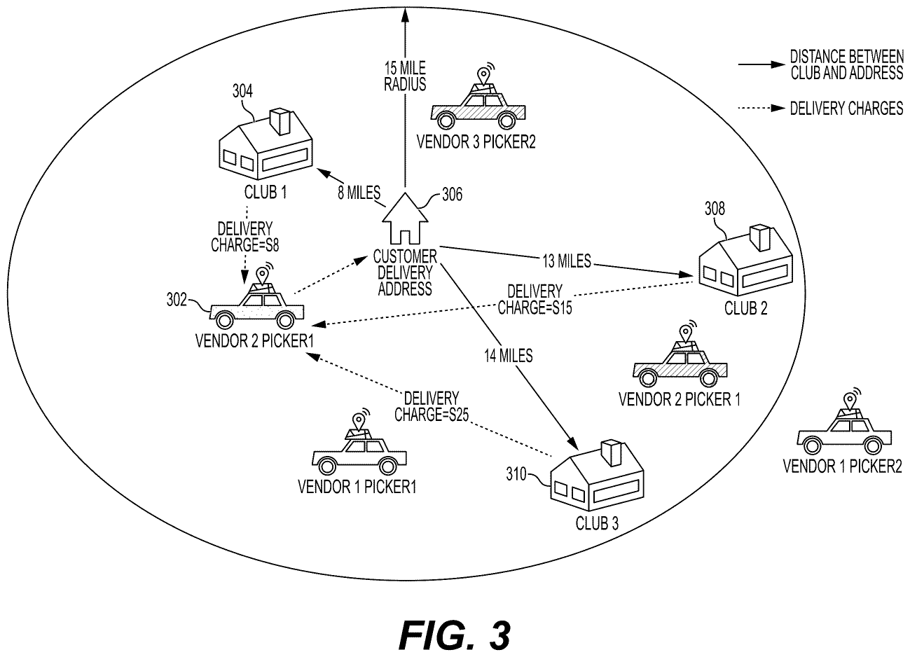

FIG. 2 illustrates an example of an enhanced architecture framework 200 (e.g., system, an enhanced architecture framework as described above, and the like), implemented according to at least one aspect of the present disclosure. In at least one aspect, the enhanced architecture framework is configured or otherwise arranged to perform methods provided herein (e.g., method 1300 of FIG. 13). Additionally, it may be understood that features of FIGS. 3-9 are inherently and broadly described with respect to the enhanced architecture framework of FIG. 2.

The enhanced data processing architecture of FIG. 2 includes unit 202, unit 204, unit 206a-c, API integration 208, database 210, database 212, and database 214. In at least one aspect, each of unit 202, unit 204, unit 206a-c, API integration 208, database 210, database 212, and database 214 may be practically implemented as one or more units, one or more databases, and/or one or more devices. In at least one aspect, each of unit 202, unit 204, and/or unit 206a-c may have at least one memory and one or more processors having computer readable instructions stored thereon, which are capable of implementing enhanced data processing schemes as part of the enhanced architecture framework 200. In at least one aspect, unit 202, unit 204, and/or unit 206a-c may have at least one memory and one or more processors having computer readable instructions stored thereon, which are capable of implementing enhanced data processing schemes as part of the function of enhanced architecture framework 200. The one or more processor(s) of unit 202, unit 204, and/or unit 206a-c may be CPUs. The one or more processor(s) of unit 202, unit 204, and/or unit 206a-c may be GPUs. Where there is more than one processor, each processor may operate independently from one another or as part of the same network of controllers and/or systems. Where multiple processors are part of the same network of controllers and/or systems, they may operate in sequence with one another, in parallel with one another, as physical components of a shared virtual machine, or as components of server-less network capable of processing decomposed flow data (e.g., a Kubernetes-based architecture).

The enhanced architecture framework 200 further includes a network 216. In at least one aspect, network 216 may be practically implemented in manner similar to network 118.

In at least one embodiment, database 210, database 212, and/or database 214 may be practically implemented as one or more databases. In at least one aspect, the database may include one or more of relational databases (RDBMS) which use structured query language (SQL) for data management, NoSQL databases (e.g., document stores, key-value stores, column-family stores, graph databases), in-memory databases, NewSQL databases, time-series databases, object-oriented databases, hierarchical databases, network databases, distributed databases, cloud databases, multimodel databases, embedded databases, and the like. Database 210, database 212, and/or database 214 may be treated as a data warehouse, data lake, data well, or another storage system. Database 210, database 212, and/or database 214 may be optimized for querying and analysis, allowing the enhanced data processing architecture methods described herein (e.g., method 1300). In at least one embodiment, API integration 208 may be updated in real-time based on information received from third-party delivery platforms (e.g., DoorDash, GrubHub, Postmates, and the like).

In at least one embodiment, API integration 208 may be comparable to API integration 114.

In at least one embodiment, unit 202 may be a communication unit. The communication unit may include one or more communication managers, such as an API gateway C 218, commerce engine 220, fulfillment system 222, and communicator 224. API gateway 218, commerce engine 220, fulfillment system 222 may be considered similar to fulfillment system 120, API gateway 122, and commerce engine 124, respectively. Additionally, fulfillment system 222 and communicator 224 may be configured or otherwise arranged to allow real-time calling between unit 202 and unit 104 (e.g., vendor hub).

In at least one embodiment, unit 204 may include a security barrier 226, a set of one or more controllers 228, a service manager 230, a logging manager 232, an event manager 234, a streaming manager 236, a Kafka producer 238, a Kafka consumer 240, a rules manager 242, a configuration manager 244, and a restrictions manager 246. In one example, SSD delivery data is delivered (e.g., in real-time) from unit 102 to security barrier 226, which may process and/or validate the SDD data and deliver the data to the set of controllers 228. The set of controllers 228 process the SDD data and deliver it to service manager 230. Service manager 230 inputs delivery vendor information (e.g., location, availability, slot information) from API integration 208, logging information from logging manager 232, event information from event manager 234, and/or streaming information from streaming manager 236 to produce output service information for a given order or event. Output service information may be processed by rules manager 242, configuration manager 244, and restrictions manager 246 to process and transform the data for storage. The processed data may then be delivered to and stored at database 210.

In one example, SDD data (such as outgoing event data) may be delivered from API integration 208 to event manager 234. Event manager 234 may also obtain logging information from logging manager 232, queuing information from Kafka consumer 240, and/or streaming information from streaming manager 236. In response, event manager 234 may output processed event information to those same components. By refining information from API integration 208, logging manager 232, Kafka consumer 240, and streaming manager 236, event manager 234 may interact with unit 206a-c.

In at least one embodiment, unit 206a-c is a serverless distributed architecture configured or otherwise arranged to implement queuing procedures according to one or more embodiments of the present disclosure (e.g., method 1300 of FIG. 13). Unit 206a-c includes 206a, 206b, and 206c. Unit 206a, which may be considered a container, is arranged or otherwise configured to que vendor events. Unit 206a inputs delivery vendor information from AIPC 218 and/or Kafka consumer 240 and outputs queue information for delivery vendor information to the same components. Unit 206b, which may be considered a container, is configured or otherwise arranged to queue consumer/user events. Unit 206b inputs information delivered by Kafka producer 238 and outputs queue information for client events. Unit 206c, which may be considered a container, is configured or otherwise arranged to process streaming information from streaming manager 236. Streaming information is delivered from streaming manager 236 to unit 206c, where unit 206c processes, sorts, and/or otherwise transforms the streaming data and outputs the streaming data to database 212. Database 212 may then output the information to database 214. In certain cases, database 212 is an Amazon WebServices (AWS) S3 bucket, and database 214 is a redshift data cluster.

In at least one embodiment, enhanced architecture framework 200 may implement one or more enhanced serviceability procedures. In one example, enhanced architecture framework 200 may select a delivery vendor who can deliver the products to customers in a cost-effective manner using data available at API integration 208, database 210, and/or units 206a-c. In at least one example, operations at enhanced architecture framework 200 may begin when a customer enters a delivery address. The entry may be received at unit 202 and processed through unit 204. Via communication with unit 206a and unit 206b, unit 204 streams a set of nearest clubs in a configured radius based on the address entered. Once the clubs have been streams, unit 204 identifies active vendors associated with enhanced architecture framework 200. After streaming active vendors at unit 206a, enhanced architecture framework 200 does a parallel availability stream against each vendor identified at API integration 208. After identifying alerting available vendors, each available delivery vendor may return their “picker” availability and a cost of performing an SDD. In one example, a picker may be a delivery driver or delivery service.

In at least one embodiment, pickers can be anywhere near the club or the delivery address but should be within the radius defined in the configuration. Each delivery vendor, based on how close their picker is to the delivery pick up location, may share a cost associated with the delivery. The delivery charge may change based on the delivery pick up location.

As illustrated in the vendor diagram of FIG. 3, if a first picker for a second delivery vendor (hereinafter, picker 302) picks up ordered items from a first club 304 and deliver the ordered items to a customer's delivery address 306, the delivery charge would be about $8. In the same example, the cost would be about $15 for a second club 308 and about $25 for a third club 310. In certain cases, the cost of SDD may vary based on the location of the picker. Where there are multiple pickers, an enhanced architecture framework may coordinate with delivery vendors to select the cheapest picker.

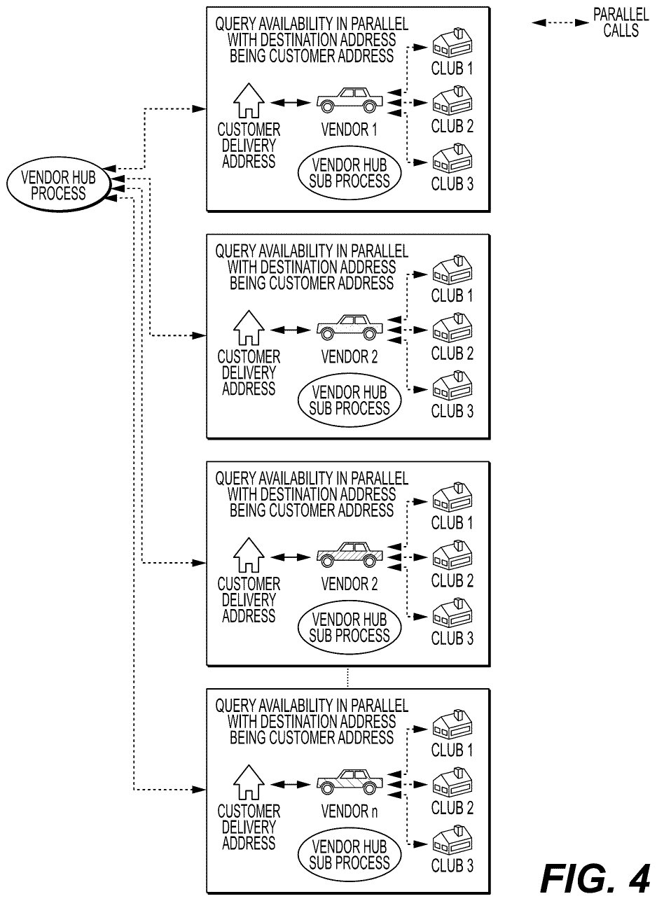

In at least one embodiment, the process described herein may be implemented in parallel. As illustrated in FIG. 4, parallel query operations may be achieved by an enhanced architecture framework (e.g., a vendor hub) querying the available vendors for a set of clubs stored in a vendor database (e.g., API integration 208) and associating those vendors with a set target delivery addresses on a per address basis. In the example shown in FIG. 4, the availability of each of Vendor 1, Vendor 2, Vendor 3, and Vendor n are queried, via a set of sub-processes, based on a vendor response to an availability query. By performing multiple availability checks in parallel, enhanced architecture frameworks may be capable of returning an availability response to a user within a shortened period of time. When a serviceability request is initiated, an enhanced architecture framework (e.g., enhanced architecture framework 100, enhanced architecture framework 200) may collect information regarding active delivery vendors at that point in time. The enhanced architecture framework may also sort the nearest clubs based on the customer address and check whether the club is enabled for SDD. The enhanced architecture framework may perform the parallel query operations of FIG. 4. The parallel query may validate each vendor, checking the serviceability of the delivery vendor against each club in their proximity range. Enhanced serviceability procedures at the enhanced architecture framework may consolidate the result from the parallel querying and prepare a report, such as the report described above.

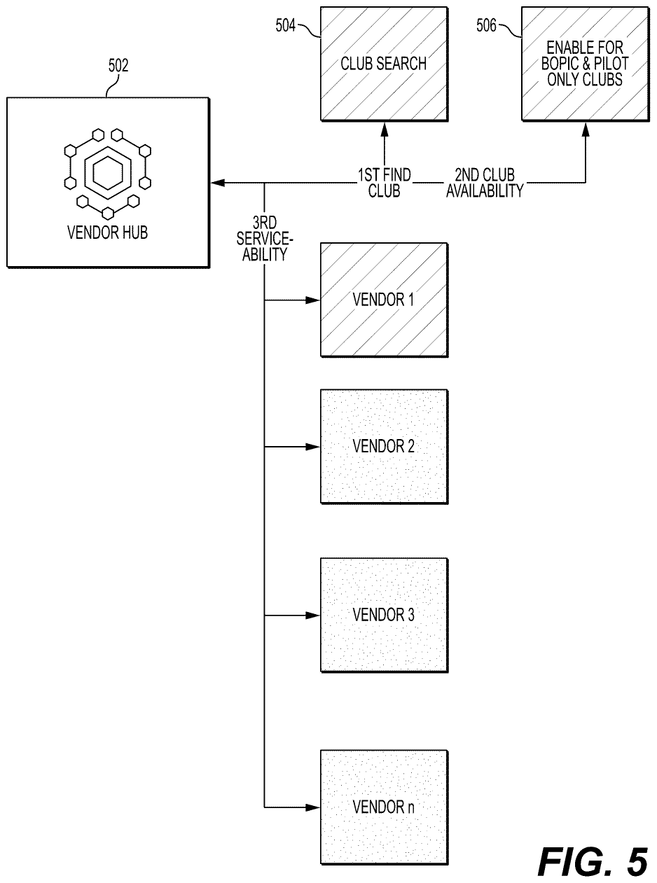

FIG. 5 is a schematic diagram illustrating communication pathways between a vendor hub 502 (e.g., an enhanced architecture framework, unit 104, unit 204), clubs, and Vendors 1-n. Vendor hub 502 may perform, via a network (e.g., network 118, network 216) a club search at operation 504 to identify any club associated with a vendor. Vendor hub 502 may also perform, via the network, a second club search at operation 506 to identify additional clubs that may be available subject to certain conditions or parameters (e.g., “bopic and pilot only” clubs). After establishing availability at operation 504 and/or operation 506, vendor hub 502 may perform enhanced serviceability procedures to determine whether any of Vendors 1-n are available for pickup and SDD via the available and identified clubs.

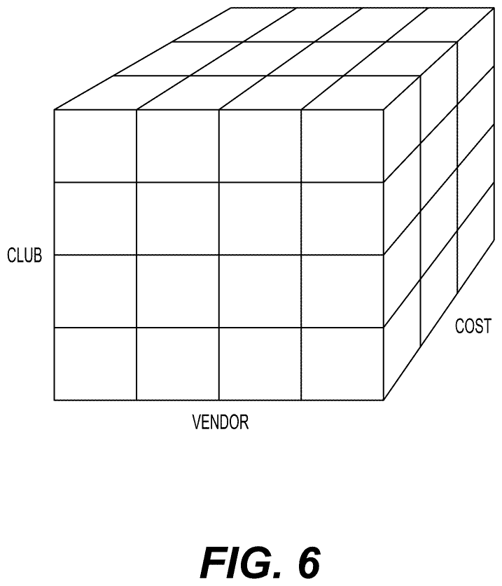

Once potential vendors and associated clubs are identified, costs for SDD are evaluated for each combination of vendor and club. Using a constructed selection matrix (e.g., such as a three dimensional graph of FIG. 6), a final vendor and club are selected based on the cost, and SDD is performed.

In at least one embodiment, an enhanced architecture framework may implement a slot-based system. A slot within the slot-based system may correspond to a given time, during which a customer expects SDD, and during which a vendor and a club may be available to perform the SDD. Aspects of the present disclosure provide systems and methods for combining slots from different vendors and clubs for SDD selection.

As illustrated in the screen illustration of FIG. 7, an enhanced architecture framework (e.g., enhanced architecture framework 100, enhanced architecture framework 200) may display a slot selection interface to a user (e.g., via a browser). When displaying slots to members to schedule the SDD drop off time, each available slot from all available vendors is displayed to increase availability for SDD. Slots from each delivery vendor may vary based on the type of delivery vendor. In one example, delivery vendors may be full-service delivery vendors that both pick up an order from a selected club and deliver an order to a customer address. In another example, delivery vendors may be “last mile” delivery vendors that perform the delivery to a customer address. Where a vendor is a delivery vendor, pick up may be performed by staff at the selected club. In either case, the enhanced architecture frameworks may display the slots by processing data regarding delivery vendor schedules (e.g., obtained via querying), construct a schedule based on the delivery vendor schedules and a set of client preference, and output a scheduling selection menu onto an interface based on the constructed schedule.

Each slot displayed at an interface can belong to one or more delivery vendors based on their availability and the availability of their associated clubs club availability. As shown in the example screenshot illustrated in FIG. 8, the 4:00 pm to 5:00 pm slot is available and associated with Vendor 1, Vendor 2, and Club Scheduler (e.g., a club courier scheduler for last mile delivery vendors). Once a slot has been selected, the enhanced architecture framework may allocate the order to any of the available delivery vendors based on preferences, serviceability, and cost. Before closing the slots based on an order, a final serviceability check may be performed.

The framework of FIG. 8 may allow the enhanced architecture framework to extend the slots functionality for multiple delivery vendors and multiple clubs to streamline the slot functionality without hampering the overall functionality. Vendors and clubs may be disabled within the slot functionality at any point in time.

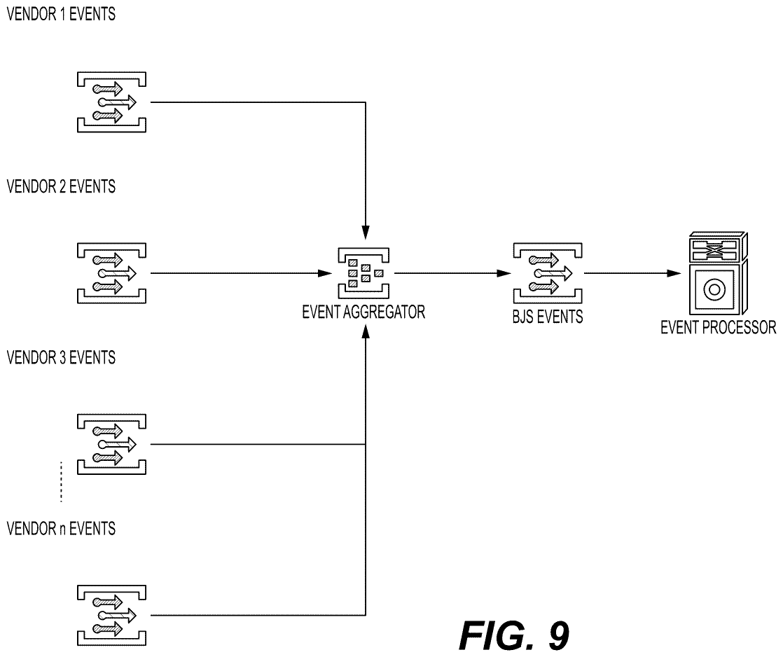

In at least one embodiment, an event manager (e.g., unit 108, unit 206, event manager 234, rules manager 242) may perform event aggregation and rule execution. The event manager may be included at a vendor hub (e.g., unit 104, unit 204, vendor hub 502) of an enhanced architecture framework (e.g., enhanced architecture framework 100, enhanced architecture framework 200), and may be configured or otherwise arranged to generate events for specific actions associated with an order. In the example illustrated in the diagram of FIG. 9, the vendor hub may transform the events from different delivery vendors (e.g., Vendor 1 through Vendor n) to unified format (e.g., a structed data format, as described above) for internal processing. The vendor hub may then process the data according to corresponding rules (e.g., such as rules stored at rules manager 242). As different vendors are integrated into the vendor hub system, each vendor may generate events for a specific action that they may take with respect to an order. For example, a “dasher_confirmed” event from Vendor 2 may indicate that a picker has been confirmed for order pickup. The vendor hub may act on some of the queued events, while other events may be tolled or ignored.

Each of the events received from a delivery vendor may be transformed into an internal event and processed. This transformation of the event allows the system to receive events from any vendor and transform the same kind of events to a generic format so that they can be uniquely processed by the event manager and downstream applications. FIG. 10 illustrates an example sheet of source events that are transformed to internal events at the vendor hub (e.g., unit 104, unit 106, unit 204, vendor hub 502) of the enhanced architecture framework. In the second line of the sheet of FIG. 10, a source event “MEM_ORDER_CONFIRM” is received from an fulfillment system (e.g., fulfillment system 120, fulfillment system 222). The source event is affiliated with a description, a processing/consuming system, a data persistence value, a data streaming value, an fulfillment system notification value, a commerce engine notification value, a notify Comm MS value, a notify vendor value, and a target event name. The target event name, which is “VEND_RESERVATION_CONFIRM” for the second line of the sheet of FIG. 10, may be internally consistent with the data structures of the vendor hub. The source system may be any of the databases or units described herein. The processing/consuming system may be any of the databases or units described herein. The data persistence value may indicate whether the data transmitted to the target system is to be maintained after the execution of the source event and/or remain accessible after the source event has ended. The data streaming value may indicate whether data is to be transmitted to a streaming manager (e.g., streaming manager 236). The fulfillment system notification value, a commerce engine notification value, a notify Comm MS value, and a notify vendor value may indicate whether to notify the respective components of any updates to the event. Additional values not pictured may also be considered.

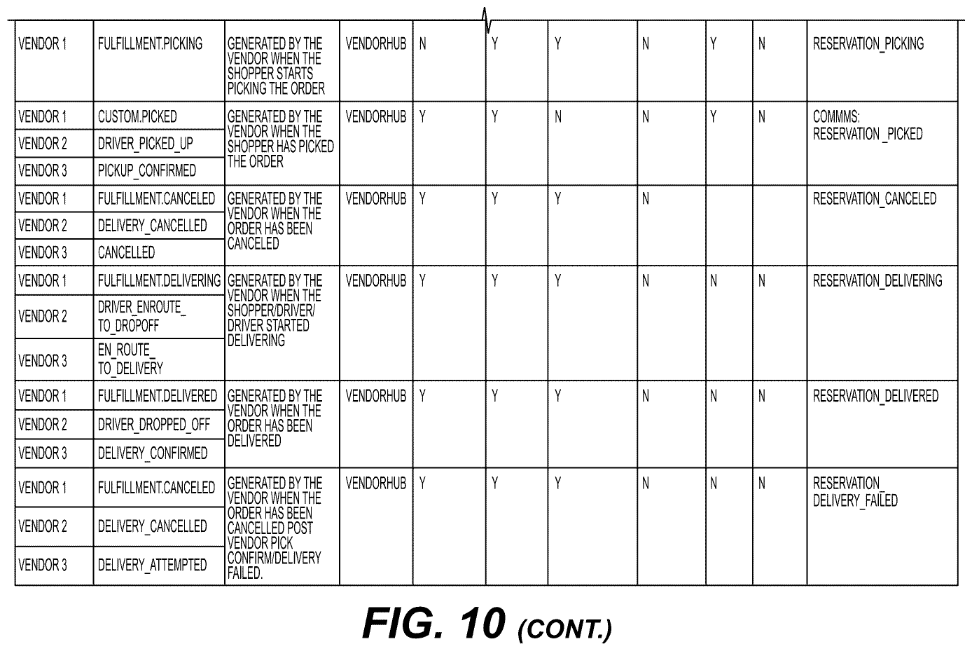

In at least one embodiment, an enhanced architecture framework may support expanded services for delivery vendors. In one example, delivery vendors may provide services like “heavy order” delivery for excessive-weight orders, alcohol delivery, and bulk order deliveries. Delivery vendors can be coordinated by the enhanced architecture framework according to the value-added service they provide. Based on whether a set of delivery vendors are performing expanded services, delivery vendors providing the service may be added, at a vendor hub (e.g., unit 104, unit 106, unit 204), to a list of selected vendors capable of performing the expanded service. There can be multiple configurations of expanded services available via one or more delivery vendors. In one example, the expanded services have a one-to-many relationship with available delivery vendors, as shown below in FIG. 11. In at least one embodiment, whether an order is eligible for SDD may depend on order content and club availability. Eligibility for an expanded service may depend on order content and current order status. For example, bulk order availability depends on the size of the initial order.

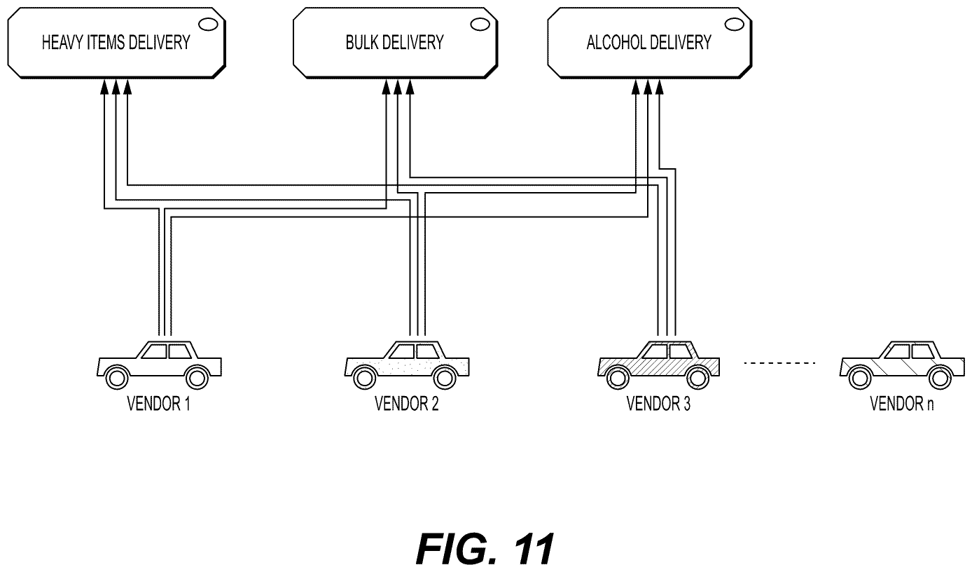

As illustrated in FIG. 12, the expanded services may be supported by the parallel query operations as described with respect to FIG. 4.

### Example Method

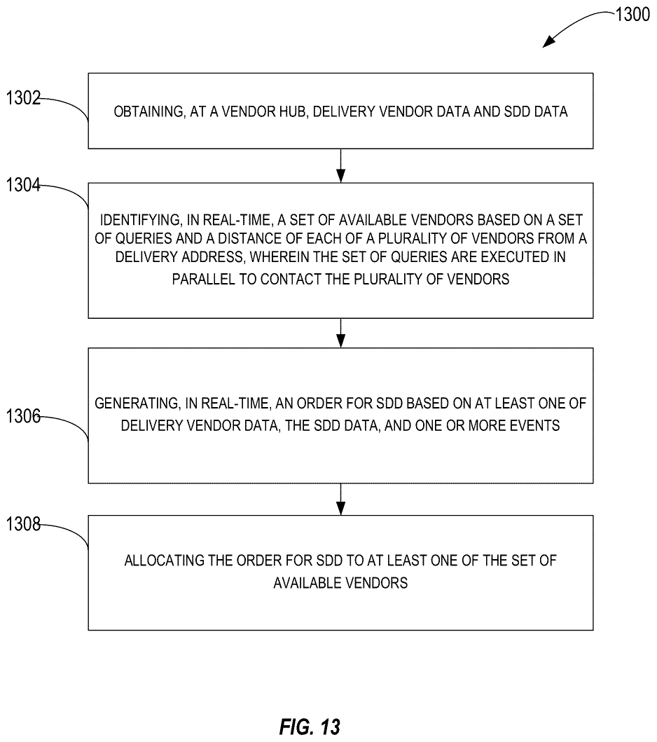

FIG. 13 is a schematic flowchart of an example method 1300 for revenue forecasting by one or more processors, such as processors of enhanced architecture framework 100 of FIG. 1, processors of enhanced architecture framework 200 of FIG. 2, and/or the processors of the system 1400 of FIG. 14.

Method 1300 optionally begins at operation 1302 with one or more processors obtaining, at a vendor hub, delivery vendor data and SDD data. In one example, the SDD data includes at least one of: club availability information, club proximity information, club inventory information, vendor availability information, vendor proximity information, vendor inventory information, customer request information, customer order information, picker availability information, and cost information. In one example, the delivery vendor data includes at least one of: delivery vendor location, delivery vendor availability, and slot information.

Method 1300 continues to operation 1304 with one or more processors identifying, in real-time, a set of available vendors based on a set of queries and a distance of each of a plurality of vendors from a delivery address, wherein the set of queries are executed in parallel to contact the plurality of vendors.

Method 1300 optionally continues to operation 1306 with one or more processors generating, in real-time, an order for SDD based on at least one of delivery vendor data, the SDD data, and one or more events.

Method 1300 continues to operation 1308 with one or more processors allocating the order for SDD to at least one of the set of available vendors.

In at least one aspect, method 1300 may include an operation by one or more processors to output the set of queries to the plurality of vendors.

In at least one aspect, method 1300 may include an operation by one or more processors to aggregate, from the plurality of delivery vendors, responses from the plurality of vendors.

In at least one aspect, method 1300 may include an operation by one or more processors to generate, based on the responses, one or more events, the one or more events comprising at least one of vendor events, consumer events, and streaming events.

In at least one aspect, method 1300 may include an operation by one or more processors to deliver to the vendor hub, the one or more events.

In at least one aspect, method 1300 may include an operation by one or more processors to queue at least one of the vendor events, the consumer events, and the streaming events.

In at least one aspect, method 1300 may include an operation by one or more processors to receive SDD information, in real-time, from any of customers, clubs, or vendors.

In at least one aspect, method 1300 may include an operation by one or more processors to deliver information regarding the order for SDD to one or more devices.

In at least one aspect, method 1300 may include an operation by one or more processors to update the order for SDD based on the SDD information.

In at least one aspect, method 1300 may include an operation by one or more processors to toll the order for SDD based on the SDD information.

In at least one aspect, method 1300 may include an operation by one or more processors to identify the set of available vendors based on whether each of the plurality of vendors offers expanded services.

In at least one aspect, method 1300 may include an operation by one or more processors to aggregate the one or more events.

In at least one aspect, method 1300 may include an operation by one or more processors to generate an alert for the set of available vendors.

In at least one aspect, method 1300 may include an operation by one or more processors to refine the one or more events.

In one aspect, method 1300, or any aspect related to it, may be performed by a system, device, apparatus, or architecture, such as the enhanced architecture of FIG. 1 of FIG. 2 or system 1400 of FIG. 14, which includes various components operable, configured to, or adapted to perform the method 1300. System 1400 is described below in further detail.

FIG. 13 is just one example of a method, and other methods including fewer, additional, or alternative operations are contemplated consistent with the disclosure.

### Example System

FIG. 14 illustrates a schematic diagram of an example system 1400, which includes a first database 1402, one or more communication managers 1418, a distributed unit 1434, and a vendor hub 1460. The system 1400 may be implemented as part of the enhanced architectures described with respect to FIGS. 1-13. First database 1402, one or more communication managers 1418, distributed unit 1434, and vendor hub 1460 may be implemented at a single location or at multiple locations and may be a supervisory system component or may be in communication with a supervisory system component by way of a communication line and/or communication connection. In at least one aspect, the communication line and/or communication connection may be a wireless communication line, a wired communication line, or both, though other types of communication line or connection are contemplated.

First database 1402 may include a CPU processing system, which may be configured to implement enhanced data processing, as performed by the system 1400. The CPU processing system of the first database 1402 may include one or more processors 1406 coupled to a computer readable medium/memory 1404 (e.g., via a bus (not shown)). The one or more processors 1406 and the computer readable medium/memory 1404 may communicate via a message passing interface (MPI) 1416. In certain aspects the computer readable medium/memory 1404 is configured to store instructions (e.g., computer executable code) that when executed by the one or more processors 1406, cause the one or more processors to perform the method 1300 described with respect to FIG. 13, or any aspect related to it. Reference to a processor performing a function of system 1400 may include one or more processors performing that function of system 1400.

In the depicted example, computer-readable medium/memory 1404 stores code 1408 (e.g., executable instructions) for storing and code 1410 for delivering. Processing of code 1408-1410 may cause the system 1400 to perform the method 1300 described with respect to FIG. 13, or any aspect related to it.

The one or more processors 1406 include circuitry configured to implement (e.g., execute) the code stored in the computer-readable medium/memory 1404, including circuitry 1412 for storing and circuitry 1414 for delivering. Processing with circuitry 1412-1414 may cause the system 1400 to perform the method 1300 described with respect to FIG. 13, or any aspect related to it.

The one or more communication managers 1418 may include a CPU processing system, which may be configured to implement enhanced data processing, as performed by the system 1400. The CPU processing system of the one or more communication managers 1418 may include one or more processors 1422 coupled to a computer readable medium/memory 1420 (e.g., via a bus (not shown)). The one or more processors 1422 and the computer readable medium/memory 1420 may communicate via a message passing interface (MPI) 1432. In certain aspects the computer readable medium/memory 1420 is configured to store instructions (e.g., computer executable code) that when executed by the one or more processors 1422, cause the one or more processors to perform the method 1300 described with respect to FIG. 13, or any aspect related to it. Reference to a processor performing a function of system 1400 may include one or more processors performing that function of system 1400.

In the depicted example, computer-readable medium/memory 1420 stores code 1424 (e.g., executable instructions) for delivering and code 1426 for receiving. Processing of code 1424-1426 may cause the system 1400 to perform the method 1300 described with respect to FIG. 13, or any aspect related to it.

The one or more processors 1422 include circuitry configured to implement (e.g., execute) the code stored in the computer-readable medium/memory 1420, including circuitry 1428 for delivering and circuitry 1430 for receiving. Processing with circuitry 1428-1430 may cause the system 1400 to perform the method 1300 described with respect to FIG. 13, or any aspect related to it.

The distributed unit 1434 may include a CPU processing system, which may be configured to implement enhanced data processing, as performed by the system 1400. The CPU processing system of the distributed unit 1434 may include one or more processors 1438 coupled to a computer readable medium/memory 1436 (e.g., via a bus (not shown)). The one or more processors 1438 and the computer readable medium/memory 1436 may communicate via a message passing interface (MPI) 1460. In certain aspects the computer readable medium/memory 1436 is configured to store instructions (e.g., computer executable code) that when executed by the one or more processors 1438, cause the one or more processors to perform the method 1300 described with respect to FIG. 13, or any aspect related to it. Reference to a processor performing a function of system 1400 may include one or more processors performing that function of system 1400.

In the depicted example, computer-readable medium/memory 1436 stores code 1440 (e.g., executable instructions) for outputting, code 1442 for aggregating, code 1444 for generating, code 1446 for delivering, and code 1448 for queuing. Processing of code 1440-1448 may cause the system 1400 to perform the method 1300 described with respect to FIG. 13, or any aspect related to it.

The one or more processors 1438 include circuitry configured to implement (e.g., execute) the code stored in the computer-readable medium/memory 1436, including circuitry 1450 for outputting, circuitry 1452 for aggregating, circuitry 1454 for generating, circuitry 1456 for delivering and circuitry 1458 for queuing. Processing with circuitry 1450-1458 may cause the system 1400 to perform the method 1300 described with respect to FIG. 13, or any aspect related to it.

The vendor hub 1460 may include a CPU processing system, which may be configured to implement enhanced data processing, as performed by the system 1400. The CPU processing system of the vendor hub 1460 may include one or more processors 1464 coupled to a computer readable medium/memory 1462 (e.g., via a bus (not shown)). The one or more processors 1464 and the computer readable medium/memory 1462 may communicate via a message passing interface (MPI) 1498. In certain aspects the computer readable medium/memory 1462 is configured to store instructions (e.g., computer executable code) that when executed by the one or more processors 1464, cause the one or more processors to perform the method 1300 described with respect to FIG. 13, or any aspect related to it. Reference to a processor performing a function of system 1400 may include one or more processors performing that function of system 1400.

In the depicted example, computer-readable medium/memory 1462 stores code 1466 (e.g., executable instructions) for identifying, code 1468 for allocating, code 1470 for delivering, code 1472 for updating, code 1474 for tolling, code 1476 for aggregating, code 1478 for generating, and code 1480 for identifying. Processing of code 1466-1480 may cause the system 1400 to perform the method 1300 described with respect to FIG. 13, or any aspect related to it.

The one or more processors 1464 include circuitry configured to implement (e.g., execute) the code stored in the computer-readable medium/memory 1462, including circuitry 1482 for identifying, circuitry 1484 for allocating, circuitry 1486 for delivering, circuitry 1488 for updating, circuitry 1490 for tolling, circuitry 1492 for aggregating, circuitry 1494 for generating, and circuitry 1496 for identifying. Processing with circuitry 1482-1496 may cause the system 1400 to perform the method 1300 described with respect to FIG. 13, or any aspect related to it.

Various components of the system 1400 may provide means for performing the method 1300 described with respect to FIG. 13, or any aspect related to it.

The system 1400 may include or be substantially coupled to a communication component 1499. In the depicted example, the communication component 1499 is an antenna capable of communicating with systems or system components similar to system 1400 to perform the method 1300 described with respect to FIG. 13, or any aspect related to it. In additional examples, the communication component 1499 may be a bus or a wired connection.

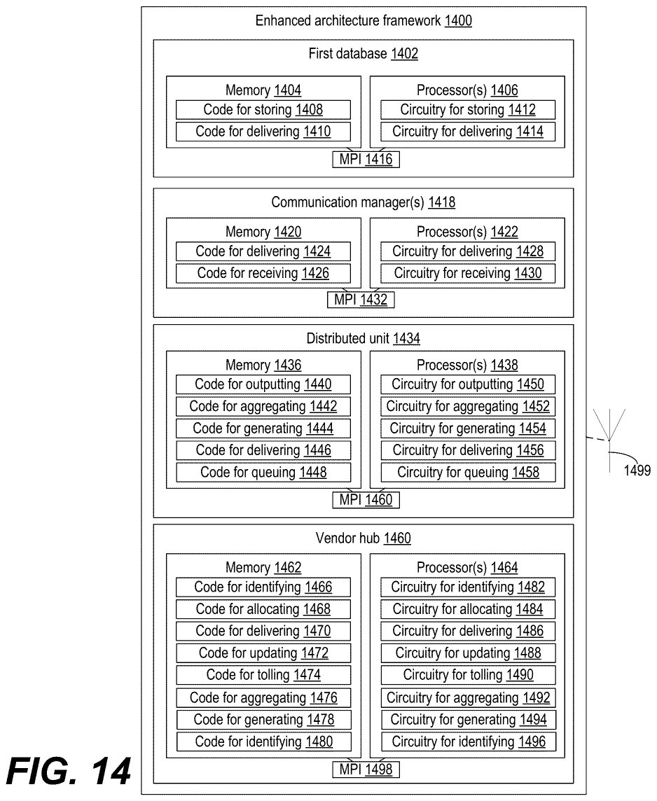

FIG. 15 is an example of a block diagram of a system 1500. The system 1500 can be implemented using one or more modules, shown in block form in the drawings. The one or more modules can be in software or hardware form, or a combination thereof. In some examples, the system 1500 can be implemented as machine readable instructions for execution on one or more computing platforms 1502 (referred to as a computing platform herein), as shown in FIG. 15. The computing platform 1502 can include one or more computing devices selected from, for example, a desktop computer, a server, a controller, a blade, a mobile phone, a tablet, a laptop, a personal digital assistant (PDA), and the like.

The computing platform 1504 can include a processor 1504 and a memory 1506. By way of example, the memory 1506 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 1504 can be implemented, for example, as one or more processor cores. The memory 1506 can store machine-readable instructions that can be retrieved and executed by the processor 1504 to implement the system 1500. Each of the processor 1504 and the memory 1506 can be implemented on a similar or a different computing platform. The computing platform 1502 can be implemented in a cloud computing environment (for example, as disclosed herein) and thus on a cloud infrastructure. In such a situation, features of the computing platform 1502 can be representative of a single instance of hardware or multiple instances of hardware executing across the multiple of instances (e.g., distributed) of hardware (e.g., computers, routers, memory, processors, or a combination thereof). Alternatively, the computing platform 1502 can be implemented on a single dedicated server or workstation.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (SaaS, platform as a service (PaaS), and/or infrastructure as a service (IaaS)) and at least four deployment models (e.g., private cloud, community cloud, public cloud, and/or hybrid cloud). A cloud computing environment can be service oriented with a focus on statelessness, low coupling, modularity, and semantic interoperability.

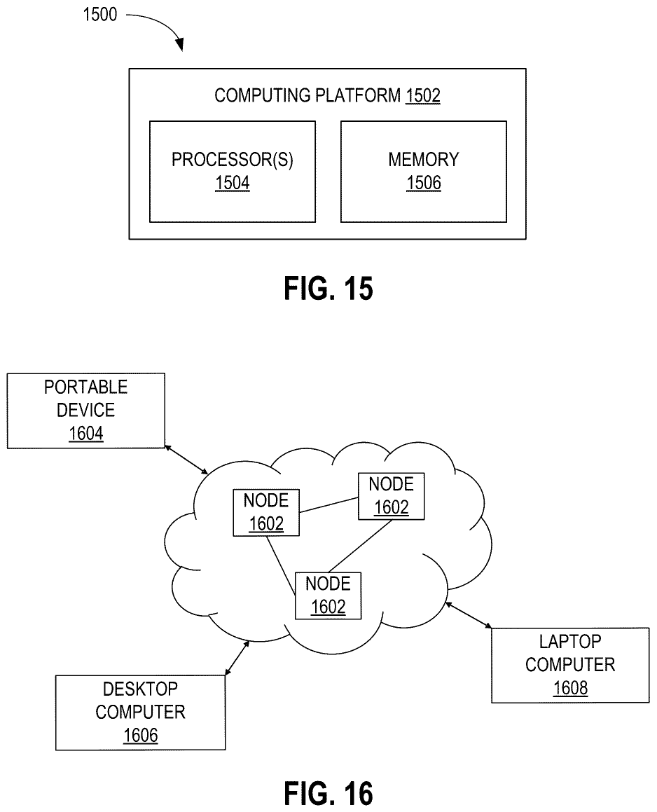

FIG. 16 is an example of a cloud computing environment 1600 that can be used for implementing one or more modules and/or systems in accordance with one or more examples, as disclosed herein. Thus, reference can be made to one or more examples of FIGS. 1-17 in the example of FIG. 16. As shown, cloud computing environment 1600 can include one or more cloud computing nodes 1602 with which local computing devices used by cloud consumers (or users), such as, for example, personal digital assistant (PDA), cellular, or portable device 1604, a desktop computer 1606, and/or a laptop computer 1608, may communicate. The computing nodes 1602 can communicate with one another. In some examples, the computing nodes 1602 can be grouped (not shown) physically or virtually, in one or more networks, such as Private, Community, Public, or Hybrid clouds, or a combination thereof. This allows the cloud computing environment 1600 to offer infrastructure, platforms, and/or software as services for which a cloud consumer does not need to maintain resources on a local computing device. The devices 1604-1608, as shown in FIG. 16, are intended to be illustrative and that computing nodes 1602 and cloud computing environment 1600 can communicate with any type of computerized device over any type of network and/or network addressable connection (e.g., using a web browser). In some examples, the one or more computing nodes 1602 are used for implementing one or more examples disclosed herein relating to root-source identification. Thus, in some examples, the one or more computing nodes can be used to implement modules, platforms, and/or systems, as disclosed herein.

In some examples, the cloud computing environment 1600 can provide one or more functional abstraction layers. It is to be understood that the cloud computing environment 1600 need not provide all of the one or more functional abstraction layers (and corresponding functions and/or components), as disclosed herein. For example, the cloud computing environment 1600 can provide a hardware and software layer that can include hardware and software components. Examples of hardware components include mainframes; RISC (Reduced Instruction Set Computer) architecture based servers; servers; blade servers; storage devices; and networks and networking components. In some embodiments, software components include network application server software and database software.

In some examples, the cloud computing environment 1600 can provide a virtualization layer that provides an abstraction layer from which the following examples of virtual entities may be provided: virtual servers; virtual storage; virtual networks, including virtual private networks; virtual applications and operating systems; and virtual clients. In some examples, the cloud computing environment 1600 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 1600, and billing or invoicing for consumption of these resources. In one example, these resources may include application software licenses. Security provides identity verification for cloud consumers and tasks, as well as protection for data and other resources. The management layer can also provide a user portal that provides access to the cloud computing environment 1600 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing resources for which a future requirement is anticipated in accordance with an SLA.

In some examples, the cloud computing environment 1600 can provide a workloads layer that provides examples of functionality for which the cloud computing environment 1600 may be utilized. Examples of workloads and functions which may be provided from this layer include mapping and navigation; software development and lifecycle management; virtual classroom education delivery; data analytics processing; and transaction processing. Various embodiments of the present disclosure can utilize the cloud computing environment 1600.

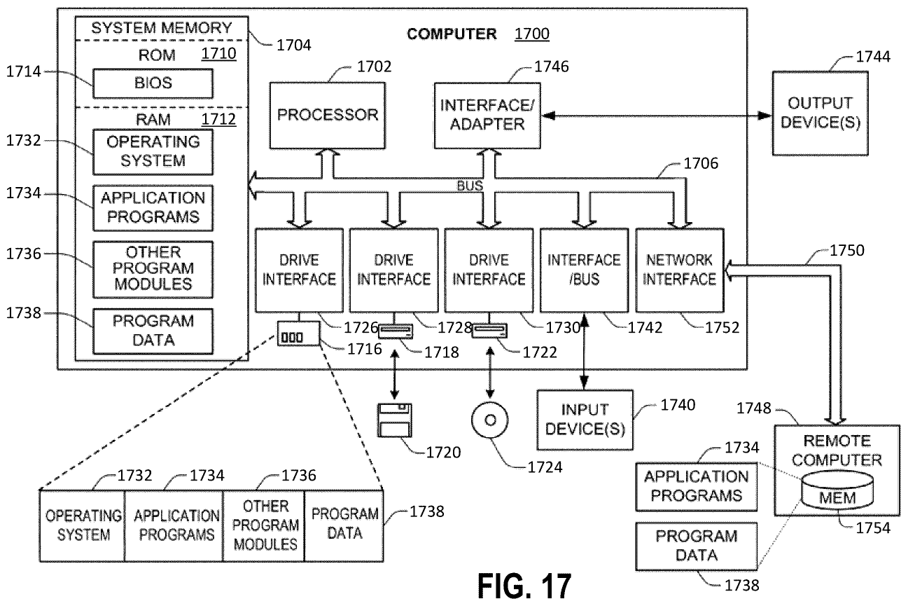

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 17. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 17 illustrates one example of a computer system 1700 that can be employed to execute one or more embodiments of the present disclosure. Computer system 1700 can be implemented on one or more general purpose networked computer systems, embedded computer systems, routers, switches, server devices, client devices, various intermediate devices/nodes, or standalone computer systems. Additionally, computer system 1700 can be implemented on various mobile clients such as, for example, a personal digital assistant (PDA), laptop computer, pager, and the like, provided it includes sufficient processing capabilities.

Computer system 1700 includes processing unit 1702, system memory 1704, and system bus 1706 that couples various system components, including the system memory 1704, to processing unit 1702. System memory 1704 can include volatile (e.g., RAM, DRAM, SDRAM, Double Data Rate (DDR) RAM, etc.) and non-volatile (e.g., Flash, NAND, etc.) memory. Dual microprocessors and other multi-processor architectures also can be used as processing unit 1702. System bus 1706 may be any of several types of bus structure including a memory bus or memory controller, a peripheral bus, and a local bus using any of a variety of bus architectures. System memory 1704 includes read only memory (ROM) 1710 and random access memory (RAM) 1712. A basic input/output system (BIOS) 1714 can reside in ROM 1710 containing the basic routines that help to transfer information among elements within computer system 1700.

Computer system 1700 can include a hard disk drive 1716, magnetic disk drive 1718, e.g., to read from or write to removable disk 1720, and an optical disk drive 1722, e.g., for reading CD-ROM disk 1724 or to read from or write to other optical media. Hard disk drive 1716, magnetic disk drive 1718, and optical disk drive 1722 are connected to system bus 1706 by a hard disk drive interface 1726, a magnetic disk drive interface 1728, and an optical drive interface 1730, respectively. The drives and associated computer-readable media provide nonvolatile storage of data, data structures, and computer-executable instructions for computer system 1700. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

Computer system 1700 may operate in a networked environment using logical connections to one or more remote computers, such as remote computer 1748. Remote computer 1748 may be a workstation, computer system, router, peer device, or other common network node, and typically includes many or all the elements described relative to computer system 1700. The logical connections, schematically indicated at 1750, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 1700 can be connected to the local network through a network interface or adapter 1752. When used in a WAN networking environment, computer system 1700 can include a modem, or can be connected to a communications server on the LAN. The modem, which may be internal or external, can be connected to system bus 1706 via an appropriate port interface. In a networked environment, application programs 1734 or program data 1738 depicted relative to computer system 1700, or portions thereof, may be stored in a remote memory storage device 1754.

### Example Aspects

Implementation examples are described in the following numbered clauses:

Aspect 1: A system for facilitating delivery, including: at least one database coupled to a first unit and configured to store delivery vendor data and deliver the delivery vendor data to the first unit; one or more communication managers implemented on a second unit and configured to deliver delivery data to the first unit; and a vendor hub implemented on the first unit, the vendor hub including at least one of: a services manager configured to identify, in real-time, a set of available vendors based on a set of queries and a distance of each of a plurality of delivery vendors from a delivery address, wherein the set of queries are executed in parallel to contact the plurality of delivery vendors; and an event manager configured to: generate, in real-time, an order identification for delivery based on at least one of delivery vendor data, the delivery data, and one or more events; and allocate the order for delivery to at least one of the set of available vendors.

Aspect 2: The system of aspect 1, further including a distributed unit configured to: output the set of queries to the plurality of vendors; and aggregate, from the plurality of delivery vendors, responses from the plurality of vendors; generate, based on the responses, the one or more events, the one or more events including at least one of vendor events, consumer events, and streaming events; and deliver, to the event manager, the one or more events.

Aspect 3: The system of aspect 2, wherein the distributed unit includes: a first container configured to queue the vendor events; a second container configured to queue the consumer events; and a third container configured to queue the streaming events.

Aspect 4: The system of any one of aspects 1 through 3, wherein the one or more communication managers implemented on the second unit include at least one of: a fulfillment system; an application programming interface (API) gateway; a commence engine; and a communication manager.

Aspect 5: The system of aspect 4, wherein the one or more communication managers are further configured to receive delivery information, in real-time, from any one of: customers, clubs, and vendors.

Aspect 6 The system of any one of aspects 1 through 5, wherein the delivery data includes at least one of: club availability information, club proximity information, club inventory information, vendor availability information, vendor proximity information, vendor inventory information, customer request information, customer order information, picker availability information, and cost information.

Aspect 7: The system of any one of aspects 1 through 6, wherein the delivery vendor data includes at least one of: delivery vendor location, delivery vendor availability, and slot information.

Aspect 8: The system of any one of aspects 1 through 7, wherein the vendor hub further includes a streaming manager configured to deliver information regarding the order for the delivery to one or more devices.

Aspect 9: The system of any one of aspects 1 through 8, wherein the event manager is further configured to: update the order for the delivery based on the delivery information; or toll the order for the delivery based on the delivery information.

Aspect 10: The system of any one of aspects 1 through 9, wherein the event manager is further configured to aggregate the one or more events.

Aspect 11: The system of any one of aspects 1 through 10, wherein the services manager is further configured to generate an alert for the set of available vendors.

Aspect 12: The system of any one of aspects 1 through 11, wherein the services manager is further configured to identify the set of available vendors based on whether each of the plurality of vendors offers expanded services.

Aspect 13: The system of any one of aspects 1 through 12, wherein the vendor hub further includes a rules manager, a configuration manager, and a restrictions manager, wherein each of the rules manager, the configuration manager, and the restrictions manager are configured to refine the one or more events.

Aspect 14: A method for delivery, including: obtaining, at a vendor hub, delivery vendor data and delivery data; identifying, in real-time, a set of available vendors based on a set of queries and a distance of each of a plurality of vendors from a delivery address, wherein the set of queries are executed in parallel to contact the plurality of vendors; generating, in real-time, an order for delivery based on at least one of delivery vendor data, the delivery data, and one or more events; and allocating the order for delivery to at least one of the set of available vendors.

Aspect 15: The method of aspect 14, further including: outputting the set of queries to the plurality of vendors; and aggregating, from the plurality of delivery vendors, responses from the plurality of vendors; generating, based on the responses, one or more events, the one or more events including at least one of vendor events, consumer events, and streaming events; and delivering, to the vendor hub, the one or more events.

Aspect 16: The method of aspect 15, further including queuing at least one of the vendor events, the consumer events, and the streaming events.

Aspect 17: The method of any one of aspects 14 through 16, further including receiving delivery information, in real-time, from any of: customers, clubs, or vendors.

Aspect 18: The method of any one of aspects 14 through 17, further including delivering information regarding the order for delivery to one or more devices.

Aspect 19: The method of any one of aspects 14 through 18, further including: updating the order for delivery based on the delivery information; or tolling the order for delivery based on the delivery information.

Aspect 20: The method of any one of aspects 14 through 19, further including identifying the set of available vendors based on whether each of the plurality of vendors offers expanded services.

Aspect 21: An apparatus or device including a memory comprising executable instructions, and a processor configured to execute the executable instructions and cause the apparatus to perform a method in accordance with any one of aspects 1-20.

Aspect 22: An apparatus or device, including means for performing a method in accordance with any one of aspects 1-20.

Aspect 23: A non-transitory computer-readable medium including executable instructions that, when executed by a processor of an apparatus, cause the apparatus to perform a method in accordance with any one of aspects 1-20.

Aspect 24: A computer program product embodied on a computer-readable storage medium comprising code for performing a method in accordance with any one of aspects 1-20.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Systems and methods provided herein may be implemented using serverless architecture, such as a “Kubernetes” architecture. Kubernetes is an open-source container orchestration platform that may manage containerized applications across a cluster of nodes. Within its architecture, several data types are integral to its operation and management. These data types include “Pods,” which are the smallest and simplest Kubernetes objects that represent a single instance of a running process in a cluster. “Nodes,” another critical data type, are the worker machines in Kubernetes, which can be either virtual or physical. Deployments are used to manage a set of identical Pods, ensuring that the desired number of Pods are running at any given time. Services, which define a logical set of Pods and a policy by which to access them, are essential for enabling network access to the Pods. “ConfigMaps” and “Secrets” are used to manage configuration data and sensitive information, respectively. “Persistent Volumes” and “Persistent VolumeClaims” handle storage resources, allowing Pods to request and use storage dynamically. Namespaces provide a mechanism to partition resources within a single Kubernetes cluster, facilitating multi-tenancy and resource management.

In Kubernetes architectures, various types of databases can be deployed to manage and store data efficiently. Relational databases, such as “MySQL” and “PostgreSQL,” are commonly used for structured data and support atomicity, consistency, isolation, and durability (ACID) transactions, making them suitable for applications requiring complex queries and data integrity. “NoSQL” databases, including “MongoDB” and “Cassandra,” are designed for unstructured data and offer high scalability and flexibility, which is ideal for applications with large volumes of data and varying data models. Key-Value stores like “Redis” and “etcd” are optimized for fast read and write operations, often used for caching and configuration management. Time-series databases, such as “InfluxDB” and “Prometheus,” are specialized for handling time-stamped data, making them perfect for monitoring and analytics applications. Additionally, “NewSQL” databases, like “CockroachDB,” combine the scalability of NoSQL systems with the ACID guarantees of traditional relational databases, providing a balanced solution for modern applications. These diverse database types enable Kubernetes to support a wide range of application requirements, from transactional systems to real-time analytics and beyond.

The present disclosure may be a system, a method, and/or a computer program product at any possible technical detail level of integration. The computer program product may include a computer readable storage medium (or media) having computer readable program instructions thereon for causing a processor to conduct aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or conduct combinations of special purpose hardware and computer instructions.

“Real-time” refers to the capability of a system or process to respond to inputs or events within a strict period of time, such as immediately or within seconds or milliseconds. In computing and information technology, real-time systems are designed to process data and provide outputs instantaneously or almost instantaneously, ensuring minimal latency.

The terminology used herein is for the purpose of describing particular embodiments only and is not intended to be limiting of the disclosure. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e. g., “about 2 to about 4” also discloses the range “from 2 to 4.” Generally, the terms “about” and “approximately” may refer to plus or minus 5-10% of the indicated number.

While the disclosure has described several exemplary embodiments, it will be understood by those skilled in the art that various changes can be made, and equivalents can be substituted for elements thereof, without departing from the spirit and scope of the disclosure. In addition, many modifications will be appreciated by those skilled in the art to adapt a particular instrument, situation, or material to embodiments of the disclosure without departing from the essential scope thereof. Therefore, it is intended that the disclosure not be limited to the particular embodiments disclosed, or to the best mode contemplated for conducting this disclosure, but that the disclosure will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A system for facilitating delivery, comprising:
at least one database coupled to a first unit and configured to store delivery vendor data and deliver the delivery vendor data to the first unit;
one or more communication managers implemented on a second unit and configured to deliver delivery data to the first unit; and
a vendor hub implemented on the first unit, the vendor hub comprising at least one of:
a services manager configured to:
identify, in real-time, a set of available vendors based on a set of queries and a distance of each of a plurality of delivery vendors from a delivery address, wherein the set of queries are executed in parallel to contact the plurality of delivery vendors;
process, based on delivery vendor schedules and a set of client preferences, slots associated with the plurality of delivery vendors to construct a schedule and output a scheduling selection menu; and
responsive to selection of a slot, perform a final serviceability check prior to closing any one of the slots; and
an event manager coupled to the services manager and configured to:
generate, in real-time, an order identification for delivery based on at least one of delivery vendor data, the delivery data, and one or more events; and
allocate the order for delivery to at least one of the set of available vendors.

2. The system of claim 1, further including a distributed unit configured to:
output the set of queries to the plurality of vendors; and
aggregate, from the plurality of delivery vendors, responses from the plurality of vendors;
generate, based on the responses, the one or more events, the one or more events comprising at least one of vendor events, consumer events, and streaming events; and
deliver, to the event manager, the one or more events.

3. The system of claim 2, wherein the distributed unit comprises:
a first container configured to queue the vendor events;
a second container configured to queue the consumer events; and
a third container configured to queue the streaming events.

4. The system of claim 1, wherein the one or more communication managers implemented on the second unit include at least one of:
a fulfillment system;
an application programming interface (API) gateway;
a commence engine; and
a communication manager.

5. The system of claim 4, wherein the one or more communication managers are further configured to receive delivery information, in real-time, from any one of: customers, clubs, and vendors.

6. The system of claim 1, wherein the delivery data comprises at least one of: club availability information, club proximity information, club inventory information, vendor availability information, vendor proximity information, vendor inventory information, customer request information, customer order information, picker availability information, and cost information.

7. The system of claim 1, wherein the delivery vendor data comprises at least one of: delivery vendor location, delivery vendor availability, and slot information.

8. The system of claim 1, wherein the vendor hub further comprises a streaming manager configured to deliver information regarding the order for the delivery to one or more devices.

9. The system of claim 1, wherein the event manager is further configured to:
update the order for the delivery based on the delivery information; or
toll the order for the delivery based on the delivery information.

10. The system of claim 1, wherein the event manager is further configured to aggregate the one or more events.

11. The system of claim 1, wherein the services manager is further configured to generate an alert for the set of available vendors.

12. The system of claim 1, wherein the services manager is further configured to identify the set of available vendors based on whether each of the plurality of vendors offers expanded services.

13. The system of claim 1, wherein the vendor hub further comprises a rules manager, a configuration manager, and a restrictions manager, wherein each of the rules manager, the configuration manager, and the restrictions manager are configured to refine the one or more events.

14. A method for delivery, comprising:
obtaining, at a vendor hub, delivery vendor data and delivery data;
identifying, in real-time and at a service manager implemented at the vendor hub, a set of available vendors based on a set of queries and a distance of each of a plurality of vendors from a delivery address, wherein the set of queries are executed in parallel to contact the plurality of vendors;
processing, at the service manager and based on delivery vendor schedules and a set of client preferences, slots associated with the plurality of delivery vendors to construct a schedule and output a scheduling selection menu; and
performing, at the service manager and responsive to selection of a slot, a final serviceability check prior to closing any one of the slots;
generating, at an event manager coupled to the service manager, implemented at the vendor hub, and in real-time, an order for delivery based on at least one of delivery vendor data, the delivery data, and one or more events; and
allocating, at the event manager, the order for delivery to at least one of the set of available vendors.

15. The method of claim 14, further comprising:
outputting the set of queries to the plurality of vendors; and
aggregating, from the plurality of delivery vendors, responses from the plurality of vendors;
generating, based on the responses, one or more events, the one or more events comprising at least one of vendor events, consumer events, and streaming events; and
delivering, to the vendor hub, the one or more events.

16. (canceled)

17. The method of claim 14, further comprising receiving delivery information, in real-time, from clubs.

18. (canceled)

19. (canceled)

20. The method of claim 14, wherein allocating the order for the delivery comprises allocating the order for last mile delivery.

21. The system of claim 1, wherein the vendor hub is further configured to perform, via a network, a club search to identify a plurality of clubs associated with the plurality of delivery vendors.

22. The system of claim 21, wherein the vendor hub is further configured to perform, via the network, a second club search to identify additional clubs that are available subject to one or more parameters.

23. The system of claim 21, wherein the vendor hub is further configured to:
determine costs of delivery for combinations of the plurality of delivery vendors and the plurality of clubs;
construct a selection matrix based on the costs; and
select a vendor and a club based on the selection matrix.
